(19) United States
(12) Patent Application Publication
(10) Pub. No.: US 2016/0223362 A1
(43) Pub. Date: Aug. 4, 2016

(54) DEVICE AND METHOD FOR MEASURING A ROTOR PARAMETER

(71) Applicant: SCHAEFFLER TECHNOLOGIES AG & CO. KG, Herzogenaurach (DE)

(72) Inventors: Olaf Werner, Buhl (DE); Michael Huber, Offenburg (DE)

(73) Assignee: Schaeffler Technologies AG & Co. KG, Herzogenaurach (DE)

(21) Appl. No.: 15/023,121

(22) PCT Filed: Nov. 19, 2014
(86) PCT No.: PCT/DE2014/200645

§ 371 Date: Mar. 18, 2016

(30) Foreign Application Priority Data
Dec. 13, 2013 (DE) 10 2013 225 831.3

(51) Int. Cl. G01D 5/244; G01D 5/245

(52) U.S. Cl. CPC G01D 5/24452; G01D 5/245

(57) ABSTRACT

The invention relates to a device for measuring a rotor parameter, including: an incremental material measure, which is connected to a rotor or stator in a rotationally fixed manner and which has increment marks, an increment-measure sensor, which is arranged facing the incremental material measure and which is arranged on the stator if the incremental material measure is connected to the rotor in a rotationally fixed manner and which is arranged on the rotor if the incremental material measure is connected to the stator in a rotationally fixed manner, and an evaluating unit. The device has a timer, which is reset and restarted each time an increment mark passes by the increment-measure sensor. In dependence on a value of the timer, the evaluating unit determines the rotor parameter for an intermediate rotational position of the rotor lying between two rotational positions of the rotor that correspond to two adjacent increment marks that the rotor passes by in succession. The invention further relates to a method for measuring a rotor parameter and to a method for reducing rotational differences of a rotor.

### BACKGROUND

The invention relates to a device and a method for measuring a rotor parameter, in particular a rotor of an electric motor (e-motor) of a hybrid module.

Resolvers that operate according to the reluctance or eddy-current principle are used for measuring the rotor position of electric machines in hybridized drivetrains. These measuring systems determine the relative angle of the rotor poles in relation to the stator poles (pole angle). Due to the mechanical structure (high number of measuring coils and poles) and the physical measuring principle, higher orders occur in time-based angular resolution that result in large errors in the case of differentiation according to time (calculation of the current angular velocity and, from this, the current rotational speed). Moreover, such resolvers are very expensive.

### SUMMARY

The inventors have therefore set the object of improving the measurement of rotor parameters, in particular to increase the accuracy and to reduce the costs of a corresponding measuring device.

The object is achieved, in particular, by a device for measuring a rotor parameter or a plurality of rotor parameters, wherein the device has:
an incremental material measure, which is connected to a rotor or stator in a rotationally fixed manner and which has increment marks,
an increment-measure sensor that is disposed opposite the incremental material measure, and that is disposed on the stator if the incremental material measure is connected to the rotor in a rotationally fixed manner, and that is disposed on the rotor if the incremental material measure is connected to the stator in a rotationally fixed manner,
and an evaluating unit,
wherein the device has a time-measuring instrument, which is set up, preferably programmed, to be reset and restarted subsequent to each passage of an increment mark past the increment-measure sensor, and wherein the evaluating unit is set up to determine, in dependence on a value of the time-measuring instrument, the rotor parameter for an intermediate rotational position of the rotor that lies between a first rotational position and a second rotational position, wherein the rotor has the first rotational position at a first instant of a passage of a first increment mark and the rotor has the second rotational position at a second instant of a passage of a second increment mark that is adjacent to the first increment mark.

The object is furthermore achieved, in particular, by a method for measuring a rotor parameter or a plurality of rotor parameters, comprising the step:
sensing a passage of an increment mark of an incremental material measure, connected to a rotor or stator in a rotationally fixed manner, past an increment-measure sensor that is disposed opposite the incremental material measure, and that is disposed on the stator if the incremental material measure is connected to the rotor in a rotationally fixed manner, and that is disposed on the rotor if the incremental material measure is connected to the stator in a rotationally fixed manner; wherein, furthermore, the following steps are performed:
starting a time-measuring instrument of an evaluating unit subsequent to a passage of a first increment mark past the increment-measure sensor, wherein the rotor has a first rotational position at the instant of the passage of the first increment mark;
resetting and starting the time-measuring instrument subsequent to a passage of a second increment mark that is adjacent to the first increment mark, wherein the rotor has a second rotational position at the instant of the passage of the second increment mark;
determining the rotor parameter in dependence on a value of the time-measuring instrument for an intermediate rotational position of the rotor that lies between the first rotational position and the second rotational position.

This makes it possible, for the first time, for a rotor parameter to be determined also for such a rotational position of the rotor, preferably a rotor of an electric motor, preferably of a hybrid-module electric motor, that lies between the rotational positions at which a passage of increment marks is detected. The accuracy of the measurement is thereby increased significantly. Preferably, with such an accurate measurement, in particular of the rotor rotational speed, a counter-excitation (active damping in a hybridized drivetrain) is performed by an electric machine, this being possible in a particularly effective manner only as a result of the accurate measurement.

The invention therefore provides a novel sensor concept for accurately measuring the current rotor rotational speed and preferably the (initial) relative angle. Additionally presented is a method for yet more accurate determination of the absolute rotor angle, based on the rotational speed measurement and a marking.

A rotor parameter is preferably a value that represents a physical state of the rotor, in particular a state in respect of the position/orientation or motion of the rotor in relation to the stator. A rotor parameter is preferably a rotational angle α or a rotational angle speed \dot{α} or a rotational speed)(a/360° or a rotational angle acceleration \ddot{α},
e.g. the rotor angle Φ [°] (angle between the current rotor position, or rotational position, and a reference rotor position, wherein 360° corresponds to one complete revolution of the rotor), the instantaneous or mean rotor angle speed \dot{Φ} [°/s], rotor rotational speed N [s⁻¹], rotor angular acceleration \ddot{Φ} [°/s²], based on the rotor angle,
or e.g. a pole angle φ [°] of an electric machine, e.g. electric motor (angle between the current rotor position, or rotational position, and a reference rotor position, wherein 360° corresponds to one revolution of the rotor, divided by the number of pole pairs P, e.g., in the case of two pole pairs, a rotation by a pole angle=360° corresponds to half of one revolution of the rotor, i.e. a rotation by a rotor angle=180°), the instantaneous or mean pole angle speed \dot{φ} [°/s], pole rotational speed n [s⁻¹] (pole angle speed divided by 360°), pole angle acceleration \ddot{φ} [°/s²], based on the rotor angle.

The following relationship exists between the rotor angle and the pole angle and the number of pole pairs P:

$$1. Φ = \frac{ϕ}{P} .$$

An incremental material measure having increment marks is preferably a marking that can be measured by a sensor and that preferably has increment marks that are repeated within the marking. Preferably, there is an equal distance between (regular) increment marks. The increment marks point to or are, for example, a periodically repeating line marking (e.g. black/white), perforation, toothing (e.g. sprocket) or fluting, magnetization or coating, that creates periodic regions that effect e.g. magnetic, optical, or capacitive discrimination. An increment mark is preferably merely a marking that is identifiable by the sensor as an increment mark. It is preferably itself disposed on a radial face or an axial face of a component of the rotor that is connected to the rotor in a rotationally fixed manner. Preferably, the incremental material measure has a multiplicity of increment marks within one rotation by 360° of a pole angle (i.e. one rotation by one pole pair).

An increment-measure sensor is preferably a sensor for sensing a passage of an increment mark past the mounting location of the increment-measure sensor. It is, for example, an optical sensor (e.g. in the case of a line marking or perforation as increment mark), or an inductive sensor, in which an electric current is induced by a passage of an increment mark (e.g. in the case of fluting/toothing, magnetization), or a distance sensor (e.g. in the case of fluting/toothing).

The passage of an increment mark is preferably sensed by a threshold value evaluation, e.g. of the induced electric current, preferably by a transistor-transistor logic circuit (TTL circuit) that emits, for example, a “high” signal if there is an increment mark present in the measuring range of the increment-measure sensor, and that emits a “low” signal if there is a region between two increment marks present in the measuring range of the increment-measure sensor.

The evaluating unit is preferably set up to receive and evaluate a sensor signal of the increment-measure sensor. It preferably has a TTL circuit, particularly preferably, alternatively or additionally, a comparator, quite particularly preferably, alternatively or preferably, a computing unit. The evaluating unit is preferably set up to receive or read out a value of the time-measuring instrument, and to reset and start the counter. It is preferably set up to perform some or all of the calculations mentioned in the following.

The time-measuring instrument is preferably a counter that, from the instant of resetting and starting the counter, permanently increases or permanently reduces a counter value according to a, preferably high-frequency, clock pulse. The counter is preferably a software counter, which is preferably clocked with a clock pulse of the computing unit and, with each clock pulse, increases a variable of a counter value by a defined constant value.

Resetting and restarting subsequent to each passage of an increment mark past the increment-measure sensor preferably means that the time-measuring instrument is reset, i.e., for example, set to zero, and restarted as soon as an increment mark (e.g. a tooth of a toothing) passes the increment-measure sensor as a result of the rotation of the rotor, and as a result of this a change in the sensor signal allows the newly passing increment mark to be detected. For example, the sensor signal triggers a TTL signal as soon as a tooth flank passes through a defined radial threshold value. The rising flank of the TTL signal starts a high-frequency software counter with a constant time step width. Upon through-passage of the next rising TTL flank, the counter status is stored, and the counter is restarted.

A rotational position is preferably a position of the rotor in respect of the stator. An intermediate rotational position is, for example, a rotor position having a rotor angle of 2.5° or 2.3° or 2.6745° if, for example, there is a respective increment mark at 0° and 5° and no increment mark in-between, such that the increment marks at 0° and 5° are adjacent.

Determining the rotor parameter for an intermediate rotational position of the rotor in dependence on a value of the time-measuring instrument preferably includes estimating or predicting a rotational position and/or speed or acceleration on the basis of a rotational position at which the passage of an increment mark was ascertained. Preferably, a plurality of differing rotor parameters are determined.

For this purpose, preferably, a measurement of the time difference between the instants of the passage, preferably of the detection of the passage, of two adjacent increment marks is performed by the time-measuring instrument, e.g. in that the counter value that the counter has as the last value before being reset is used as a time difference. The time difference and the knowledge of the number of increment marks for a defined angular range (e.g. 30 increment marks for 360°) is then used to calculate the mean angular velocity for the time of the rotation, from the increment mark that passed the sensor before the first increment mark, to the first of the two increment marks. This is preferably effected using the formula

$$\dot{α} ( {t}_{1} - {t}_{0} ) = \frac{{α}_{1} - {α}_{0}}{{t}_{1} - {t}_{0}} \qquad ( Equation 1 )$$

wherein

\dot{α}: is the angular velocity [°/s] (e.g. taking account of the further exemplary values: 12°/0.1 s or 120°/s),

t₀: is the instant (e.g. counter status, e.g. usually due to the 0 resetting) of the passage of the increment mark that passed the sensor before the first increment mark,

t₁: is the instant (e.g. counter status, e.g. 100, from which, taking account of the clock pulse of, for example, 1 kHz, there results a time difference of 0.1 s) of the passage of the first increment mark,

α₀: is the rotational angle (e.g. 0°) at the instant to,

α₁: is the rotational angle (e.g. 12°) at the instant t₁.

The angle difference α₁−α₀ is known, for example, by knowledge of the number of increment marks for a defined angular range (e.g. in the case of 30 increment marks for 360°, there is a resultant angle difference of 12°). α is preferably Φ or φ. For example, two TTL flanks are used, with knowledge of the tooth spacing, to calculate the, preferably mean, rotational speed between two teeth (tooth-to-tooth). The rotational speed is preferably recalculated with the passage of each increment mark, e.g. tooth.

Preferably, a rotor parameter is calculated for an intermediate rotational position between the first increment mark and the second increment mark that is adjacent to the first increment mark, preferably taking into account the calculated angular velocity. Preferably, the rotational angle is determined for an intermediate rotational position, preferably according to the prediction formula

α(t*)=α(t₁)+\dot{α}(t₁−t₀)·(t*−t₁), (Equation 2)

particularly preferably according to the formula

α(t*)=α(t₁)+\dot{α}(t₁−t₀)·(t*−t₁)+½\ddot{α}(t₁−t₀)·(t*−t₁)² (Equation 3)

wherein

t*: is the instant at which the rotor is in the intermediate rotational position,

\ddot{α}: is the acceleration of the rotor (time differentiation of the angular velocity),

α(t₁): is the rotational angle at the instant t1.

The instants t0, t1 and t* are each known by the time-measuring instrument, e.g. counter. Particularly preferably, the angular velocity and/or rotational acceleration are/is determined for an intermediate rotational position, e.g. by single or double time differentiation of the rotational angle for the intermediate rotational position. α is preferably Φ, particularly preferably φ. Alternatively or additionally, the rotational acceleration in the intermediate rotational position is preferably determined by evaluation of the torque of a torque sensor.

Preferably, a future developing angle within any given intermediate rotational position, e.g. tooth gap, is thus estimated, by the rotational speed sensors, from the, preferably mean, rotational speed (and preferably a mean acceleration determined from the rotational speed or the instantaneous moment balance on the sensor) between two increment marks, e.g. teeth. This angle estimate is preferably refreshed after each increment mark, e.g. tooth, which represents an angle calibration. The process of estimating and refreshing between two teeth results in a high angular accuracy.

In the case of a further device according to the invention, the evaluating unit is set up to determine an absolute rotational angle, as a rotor parameter, by at least one inductance measurement of an electric motor that is coupled to the rotor or to which the rotor belongs.

In the case of a further method according to the invention, an absolute rotational angle is determined, as a rotor parameter, by at least one inductance measurement of an electric motor that is coupled to the rotor or to which the rotor belongs.

It is thereby possible to effect an initial absolute angle measurement, which provides a value for an absolute rotational angle, in particular an absolute pole angle, once the sensor is switched on, without the need for a calibration run. With this information, in particular with the absolute pole angle, it is possible to achieve, for example, a commutation of an electric machine, from standstill, that is effective from the beginning.

Preferably, an initial angle measurement is effected for an absolute rotational angle (e.g. absolute rotor angle or absolute pole angle for determination of the relative angular position of the rotor poles in relation to the stator poles upon switch-on) by an impedance measurement upon switch-on of the device.

An absolute rotational angle is, for example, an absolute rotor angle (0 to 360°, absolute in respect of one complete rotor revolution) or an absolute pole angle (0 to 360°, absolute in respect of one rotation of the rotor by 360°/P, P=number of pole pairs).

The inductance of the stator, in the case of a rotor rotational speed of 0 rpm, is a function of the rotor angle. For example, for the purpose of determining the absolute rotational angle, a sinusoidal test voltage is modulated-on into the three phases of the stator winding. The impedance is determined from the voltage response. From the impedance, and with knowledge of the test voltage frequency, the inductance and consequently the rotational angle are determined. This method provides two items of angle information that are offset by 180°. In order to deduce the real rotational angle, preferably a positive d-current is impressed briefly, and then a negative d-current is impressed briefly (q-current virtually 0), d being the real part of the current and q being the imaginary part of the current in the rotor-based coordinate system. The unambiguous rotor angle is then deduced by observation of the inductance.

In the case of a further device according to the invention, the latter additionally has an absolute material measure that is preferably connected to the incremental material measure in a rotationally fixed manner, and an absolute-measure sensor that is disposed opposite the absolute material measure.

In the case of a further method according to the invention, there is additionally performed the step:
measuring an absolute rotational angle, by an absolute material measure that is preferably connected to the incremental material measure in a rotationally fixed manner, and by an absolute-measure sensor that is disposed opposite the absolute material measure.

It is thereby possible to effect an initial absolute angle measurement in an additional or alternative manner, as compared with an impedance measurement.

Preferably, an initial angle measurement of an absolute rotational angle (e.g. absolute rotor angle or absolute pole angle for determination of the relative angular position of the rotor poles in relation to the stator poles upon switch-on) is effected by the absolute-measure sensor upon switch-on, preferably by a distance measurement.

An absolute material measure preferably has discrete absolute marks, particularly preferably a continuous absolute measure in the region in which an absolute value is encoded, which absolute marks or absolute measure can be read out or measured by the absolute-measure sensor. For example, the absolute material measure has a distance measure (e.g. encoder contour), an optically evaluable rotary encoder or capacitive, inductive or magnetic encodings. It is preferably disposed axially next to the incremental material measure, on a radial face of an encoder wheel, or radially inside or outside of the incremental material measure, on an axial face of a component that is kinematically connected to the rotor, preferably in a rotationally fixed manner, or of the rotor itself. The absolute material measure, e.g. encoder contour, in this case preferably encodes the absolute angle and preferably the direction of rotation in relation to an electric pole. Preferably, the number of pairs of minimum and maximum values of the absolute material measure is equal to the number of pole pairs of the electric machine (e.g. number of max/min pairs of the encoder contour=number of pole pairs of the electric machine). Although this means that an unambiguous, absolute rotor angle cannot be determined, it is nevertheless possible to determine an unambiguous pole angle, and with a greater accuracy (e.g. with a radial modulation extent of the encoder contour being the same). An absolute material measure, in particular an encoder wheel contour, is preferably designed such that a direction of rotation can be detected. For example, a distance measurement (apart from a region of a step change) decreases continuously in one direction and increases continuously in the other direction.

An absolute-measure sensor is preferably set up to determine an absolute rotational angle, preferably also a direction of rotation, from an absolute mark, or to output a signal by which the evaluating unit determines an absolute rotational angle, preferably also a direction of rotation.

Preferably, the determination of the rotor parameter for a rotational position, by the increment mark, or for an intermediate rotational position is additionally effected in dependence on the absolute rotational angle. For example, the absolute rotational angle at the instant t1 is used, as α(t₁) in Equation 2 and Equation 3. Preferably, in addition, determination is effected yet more accurately using knowledge of the tooth division α(t₁). For example, the accuracy Δa (e.g. ±1°) of the identification of the absolute rotational angle by the absolute material measure is less than the accuracy Δr of the identification increment mark (e.g. ±0.5°). By combining the absolute rotational angle \tilde{α}(t₁) (e.g. 39.8°) that can be measured with an inaccuracy of Δa (e.g. ±1°) at the instant of the passage of an increment mark and the knowledge of the increment-mark subdivision Δi (e.g. 360°/100 marks, first mark at 0°), α(t₁) is determined (e.g. according to

$$α ( {t}_{1} ) = R \frac{\tilde{α} ( {t}_{1} )}{Δ i} \cdot Δ i + Δ r , \qquad ( Equation 4 )$$

wherein R(x) is a rounding operator that rounds to the next whole number. For example, the more accurate absolute rotational angle 39.6°±0.5° is then obtained, instead of 39.8°±1° previously). This is particularly advantageous if, for example, the measurement of the absolute rotational angle is limited in its accuracy to sensor and/or encoding tolerances, e.g. the distance tolerances of an encoder contour.

In the case of a further device according to the invention, the absolute material measure has an encoder contour, and the absolute-measure sensor is a distance sensor that is set up to measure a distance from the encoder sensor.

In the case of a further method according to the invention, the measuring of the absolute rotational angle is effected by a distance measurement between a distance sensor, realized as an absolute-measure sensor, and an encoder contour of the absolute material measure.

The use of a distance sensor in combination with an encoder contour is a simple, inexpensive solution for angle measurement, since distance sensors can be procured inexpensively as functionally complete units and can be used in a simple and flexible manner. Preferably, the device is suitable for contactless angle measurement, in that the distance sensors provided are set up to contactlessly measure the distance from the material measure.

The device preferably has one or more distance sensors, the distance sensors provided being set up to measure the distance from the encoder contour and to output a value for the measured distance as a signal, the provided distance sensors being disposed on the stator if the encoder contour is disposed on the rotor, or the provided distance sensors being disposed on the rotor if the encoder contour is disposed on the stator. If there is only one distance sensor, the mention of the provided distance sensors relates to the provided distance sensor.

The encoder contour is preferably a component that embodies, in respect of the rotation axis of the rotor, a radial and/or axial, angle-dependent distance measure, preferably by a face. For example, it has a surface, as a contour, which has a radial distance from the rotation axis, or axial distance from an axial fixed point, that varies according to the angular position of the rotor. Preferably, the encoder contour has a maximum and a minimum in which the distance measure is maximum and minimum, particularly preferably a number of pairs, consisting of a maximum and a minimum equal to the number of pole pairs of the electric motor. Preferably a maximum is directly next to a minimum, having a step change as a transition. The encoder contour is, for example, a preferably annular disk/(hollow) cylinder, the outer and/or inner circumferential surface of which embodies the angle-dependent measure as a contour, or it is a free-form (or a free-form component) having a specially selected surface form or surface forms, e.g. an outer and/or inner contour that embodies the angle-dependent measure as a contour. Alternatively or additionally, the measure may be embodied, for example, by the upper side and/or underside (axial end face) of a disk or of a cylinder or of a free-form.

A possible distance sensor is, for example, a distance sensor having a measurement principle, or any combination of measurement principles, as follows: inductive, optical (e.g. infrared or laser), acoustic, capacitive, Hall distance sensor, triangulation. Also possible is a distance sensor having a contact feeler, which traces the encoder contour and from the mechanical deformation or deflection of which the measured distance quantity is determined. Commercially available distance sensors are particularly preferred. Preferably, the distance sensor is set up to measure the distance from the encoder contour when the rotor is at a standstill and when in rotation. A distance signal emits a signal that is preferably proportional to the distance from the encoder contour. The signal is preferably digitally encoded for further use. The circuitry necessary for outputting the signal is preferably integrated in the distance sensor, e.g. on a printed circuit board of the sensor or in a component housing of the sensor. Required circuitry is thereby shifted into the sensor, and an angle-dependent signal is obtained without the need for application-specific circuitry. Depending on the application, this signal is a voltage, a current or a digital signal. Preferably, the provided distance sensors are opposite the encoder contour. For example, a distance sensor with an axially disposed encoder contour lies on an axial line (i.e. on a line parallel to the rotation axis) and, in the case of a radially disposed encoder contour, the latter lies with the distance sensor on a radial line. Preferably, the region of the sensor that emits and/or receives the measuring signals for distance measurement, i.e. the measuring head, is directed toward the encoder contour.

A distance from the encoder contour is preferably a distance, particularly preferably the shortest distance, between the distance sensor and the encoder contour.

In the case of a further device according to the invention, the increment-measure sensor and the absolute-measure sensor are offset relative to each other by an angle in the range of from 45° to <180°.

This is particularly effective in reducing measuring errors in measurement of an absolute rotational angle by the absolute-measure sensor, since two differing direction components of an offset can be measured, and since a comparatively easily calculated mutual compensation of the two sensors is possible. Particularly preferably, the increment-measure sensor and absolute-measure sensor are offset by 90° relative to each other. Preferably, a radial or axial offset of the incremental material measure and/or of the absolute material measure is detected by the sensors and compensated by a software algorithm. Particularly preferably, a radial offset (e.g. y) with respect to the one sensor, in particular with respect to the absolute-measure sensor, is detected by this sensor, and a compensation of the rotational angle error (e.g. a), caused by the offset, of the rotational angle measurement performed by the other sensor, in particular by the increment-measure sensor, is effected in dependence on the detected offset. This is very advantageous, in particular, in the case of the sensors having an offset angle of 90°, since this results in an easily solved trigonometric relationship between the offset measured by the one sensor and the rotational angle error on the other sensor:

a=arctan(y/r), (Equation 5)

wherein

a: is the rotational angle error on the other sensor, preferably in [°],

y: is the differential amount detected by the one sensor, and

r: is the radius of the material measure assigned to the other sensor.

Alternatively, the arcsin function may also be used (e.g. if this is easier to calculate) for estimating the rotational angle error in (Equation 5), instead of the arctan function:

a=arcsin(y/r). (Equation 5′)

For example, an offset with respect to an absolute-measure sensor or increment-measure sensor is first detected, in that at least one minimum and/or maximum measured sensor value is compared with a minimum and/or maximum reference sensor value. A minimum or maximum sensor value (e.g. distance in the case of a distance sensor) is, for example, such a minimum or maximum sensor value that was present at the beginning, when the measuring device was still correctly set. It may have been determined, e.g. by a reference pass, and stored. Alternatively or additionally, it may also be defined by a threshold value, e.g. determined by the assembly plans. If the measured minimum or maximum sensor value differs from the minimum or maximum reference sensor value by a differential amount, there is a misalignment that, without compensation, results in a rotational angle error. The rotational angle error is therefore compensated on the basis of this differential amount.

In the case of a distance sensor, the compensation is preferably effected, e.g. by shifting the measured sensor values upward or downward, by the differential amount between a distance maximum and/or minimum and a reference distance maximum and/or minimum. Alternatively or additionally, the rotational angle error a of the rotational angle measurement that is performed by the increment-measure sensor offset by 90° with respect to the distance sensor is calculated on the basis of this differential amount. The calculation is effected according to Equation 5 or Equation 5′, with a as the rotational angle error of the measurement by the increment-measure sensor, y as the differential amount measured by the distance sensor, and r as the radius of the incremental material measure. The rotational angle error is then subtracted from or added to the rotational angle determined by the increment sensor, preferably according to the sign of the differential amount, or a detection threshold value is shifted upward or downward, preferably by the differential amount and according to the sign thereof.

Preferably, at least two differing direction components of an offset are measured, one component by the increment-measure sensor and the other component by the absolute-measure sensor, and the offset compensated in respect of both direction components.

In the case of a further device according to the invention, the rotor parameter or one of the rotor parameters is a rotational angle, and the evaluating unit is set up, after a determination of an absolute rotational angle, to switch over to an absolute rotational angle determination on the basis of the incremental material measure.

In the case of a further method according to the invention, the rotor parameter or one of the rotor parameters is a rotational angle, and there is additionally performed the step:
switching over to an absolute rotational angle determination on the basis of the incremental material measure, after the determination of an absolute rotational angle, preferably as soon as an impedance measurement has been performed and/or a reference mark has been detected.

Thus, after a determination of an absolute rotational angle, e.g. after passage of a reference mark, a switchover can be effected from the initial angle measurement, based on the low-accuracy absolute material measure, to the angle prediction, based on the high-accuracy incremental material measure. This is particularly advantageous if the accuracy of the absolute material measure (e.g. ±4°) is less than the rotational angle distances of the increment marks (e.g. in the case of 360°/100 marks: 3.6°). Moreover, there is then also only one sensor required for accurate angle measurement, which saves energy.

Determination of an absolute rotational angle is effected, for example, by the already described impedance measurement of an electric motor and/or by detection of a reference mark.

Preferably, the value of the absolute rotational angle is assigned to the determination of the rotor parameter on the basis of the incremental material measure.

A reference mark is preferably a marking in a material measure that can be measured with high precision in comparison with, for example, the absolute material measure. This is, for example, the discrete step change (from maximum to minimum) at the end of an encoder contour ramp, and preferably an increment mark of the incremental material measure, e.g. tooth of the toothed wheel, that can be unambiguously assigned to the step change. Alternatively or additionally, the reference mark is an intentionally inserted greater distance (e.g. one or more tooth gaps) between increment marks. Preferably, the number of reference marks of a material measure is equal to the number of pole pairs of the electric machine. In this way, the reference marks each mark an absolute pole angle. Although this means that an unambiguous, absolute rotor angle cannot be determined, it is nevertheless possible to determine an unambiguous pole angle, and with a greater accuracy (e.g. with an equal radial modulation extent of the encoder contour).

The object is furthermore achieved, in particular, by a method for reducing rotational inequalities of a rotor of an electric motor, or of a rotor that is kinematically connected to the rotor of the electric motor, preferably in a rotationally fixed manner, preferably in a drivetrain, wherein the method comprises the steps:
measuring a rotor parameter;
controlling the electric motor in dependence on the rotor parameter for the purpose of generating a vibration-damping moment upon the rotor, characterized in that
the measuring is effected according to a method as discussed herein.

Rotational inequalities in a drivetrain are thereby reduced.

Preferably, the residual rotational inequalities that are present after a vibration damper in a hybridized drivetrain are reduced or eliminated by a counter-moment, according to the physical principle of destructive interference. For the purpose of determining this counter-moment, the current rotational speed is measured accurately, preferably with an uncertainty of <1 rpm, as a rotor parameter of the electric machine. The measurement is preferably effected by the device according to the invention and/or the method according to the invention. Preferably, the controlling of the electric motor is effected in dependence on the rotor parameter for the purpose of generating a vibration-damping moment upon the rotor, according to the method described in DE 10 2012 209 275 A1, in particular according to claims 2-10 and FIG. 2 therein.

Kinematically connected means, preferably, that the kinematically connected component rotates as a consequence of a rotation of a component.

### BRIEF DESCRIPTION OF THE DRAWINGS

The invention is now illustrated exemplarily on the basis of drawings. Shown are:

FIGS. 1a, 1b, 1c a device according to the invention for measuring a rotor parameter or a plurality of rotor parameters in states having differing rotor angles,

FIG. 2 a diagram to illustrate the steps of sensing a passage of an increment mark, starting a time-measuring instrument of an evaluating unit, and resetting and starting the time-measuring instrument,

FIGS. 3a, 3b, 3c differing views of a device based on FIG. 1, the device additionally having an absolute material measure and an absolute-measure sensor that is disposed opposite the absolute material measure,

FIG. 4 a diagram to illustrate the step of measuring an absolute rotational angle,

FIG. 5 an arrangement of increment-measure sensor and absolute-measure sensor with a mutual offset of 90° and an indicated misalignment, and

FIG. 6 a diagram to illustrate the computational compensation of the misalignment shown in FIG. 5.

### DETAILED DESCRIPTION OF THE PREFERRED EMBODIMENTS

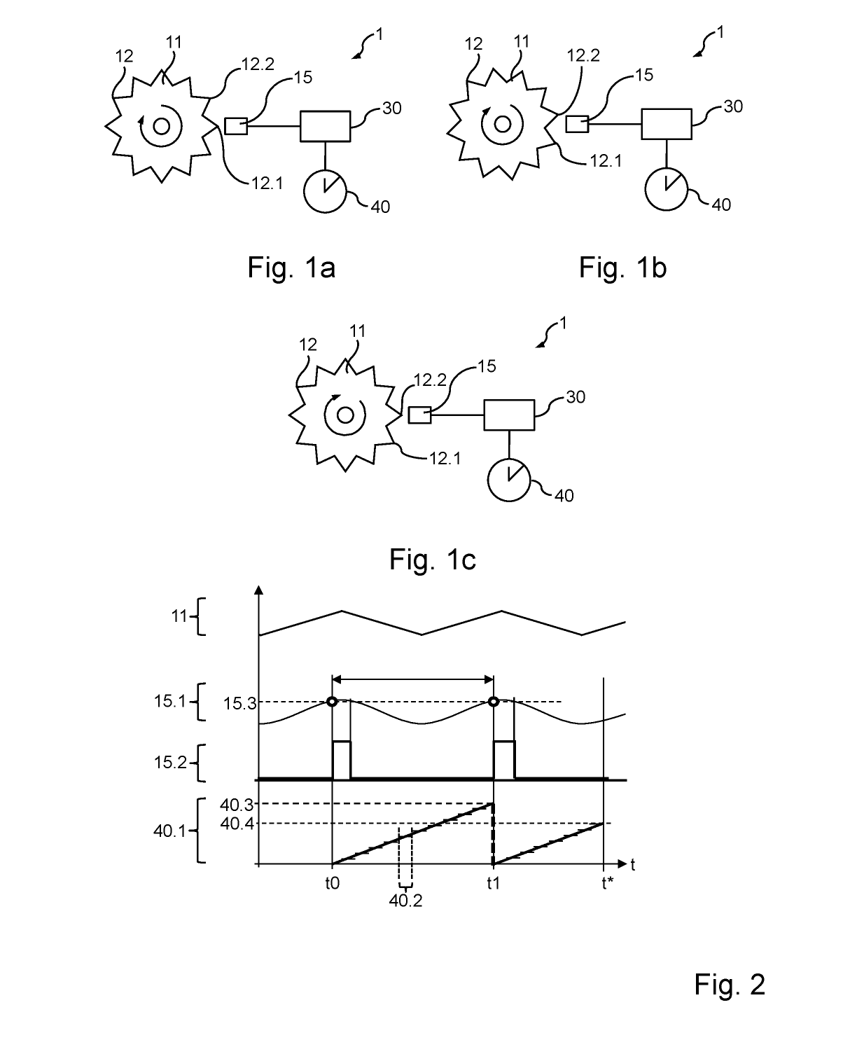

FIGS. 1a, 1b, 1c show a device 1 according to the invention for measuring a rotor parameter or a plurality of rotor parameters in states having differing rotor angles. The device 1 has an incremental material measure 11, having increment marks 12, that is connected to a rotor in a rotationally fixed manner. An increment-measure sensor 15 is disposed opposite the incremental material measure 11. Here, the incremental material measure is a toothing, and an increment mark 12 is a tooth. The device 1 additionally has an evaluating unit 30, which is connected to the increment-measure sensor 15, and a time-measuring instrument 40, which is connected to the evaluating unit. Two or all three of the components, evaluating unit 30, time-measuring instrument 40 and increment-measure sensor 15, may exist as an integral module. The time-measuring instrument 40 is set up to be reset and restarted by a passage of each increment mark 12, e.g. by the evaluating unit 30. The evaluating unit 30 is set up to determine a rotor parameter, e.g. the rotor angle for an intermediate position, as shown in FIG. 1b. The intermediate position lies between a first rotational position, which the rotor has assumed at the instant of the passage of a first increment mark 12.1, as shown in FIG. 1a, and a second rotational position, which the rotor has assumed at the instant of the passage of a second increment mark 12.2, as shown in FIG. 1c. The instant of the passage of the first and the second increment mark 12.1 and 12.2, respectively, is, for example, the instant at which the evaluating unit detects the passage of the corresponding increment mark 12.1 or 12.2.

FIG. 2 shows a diagram to illustrate a practical possibility for executing the steps of sensing a passage of an increment mark 12, starting a time-measuring instrument 40 of an evaluating unit 30, and resetting and starting the time-measuring instrument 40, e.g. by the device according to FIGS. 1a, 1b and 1c. The diagram shows the time characteristic of the incremental material measure 11 (here using the example of the sawtooth-type incremental material measure 11 from FIGS. 1a to 1c) from the point of view of the increment-measure sensor 15, the increment-measure sensor signal 15.1, beneath that a conditioned signal 15.2, and beneath that a time-measuring instrument signal 40.1 of the time-measuring instrument 40 having a time resolution 40.2. The time-measuring instrument 40 is a clock-pulsed software counter, and the time-measuring instrument signal 40.1 is a time-variable counter status. The increment-measure sensor 15 emits a signal 15.1 that is approximately proportional to the contour of the toothing. By comparison of the signal 15.1 with a threshold value 15.3, by a TTL circuit that is assigned to the evaluating unit or the sensor 15, or integrated therein, the conditioned signal 15.2 is generated. The TTL circuit emits a “high” signal if the signal 15.1 is above the threshold value and there is thus an increment mark 12 present in the measuring range of the increment-measure sensor 15. Otherwise, a “low” signal is output. At the instant t* the rotor is in an intermediate rotational position, in which there is no increment mark 12 present in the measuring range of the sensor 15, as shown in FIG. 1b. The first increment mark 12.1 passed the sensor 15 at the instant t1, as shown in FIG. 1a, and the second increment mark 12.2 has not yet passed the sensor 15. At the instant t0, the instrument mark 12.1 preceding the first increment mark passed the sensor 15. Upon detection of a switchover of the signal 15.2 to a “high” level, the attained counter status is stored, the counter is reset and restarted. At the instant t* a calculation of the estimated rotor angle at the instant t* is effected as a rotor parameter, for example, in that the attained counter status 40.3 at the instant t1 is first used to calculate a mean rotor angle velocity in the time range from t0 to t1, e.g. according to the formula Equation 1 mentioned in the description. The rotational angle at the instant t* is then determined on the basis of the calculated rotor angle velocity and the attained counter status 40.3 at the instant t*, e.g. according to the formula Equation 2 or Equation 3 mentioned in the description.

Accurate determination of, for example, the rotor angle is thereby possible, even in intermediate positions.

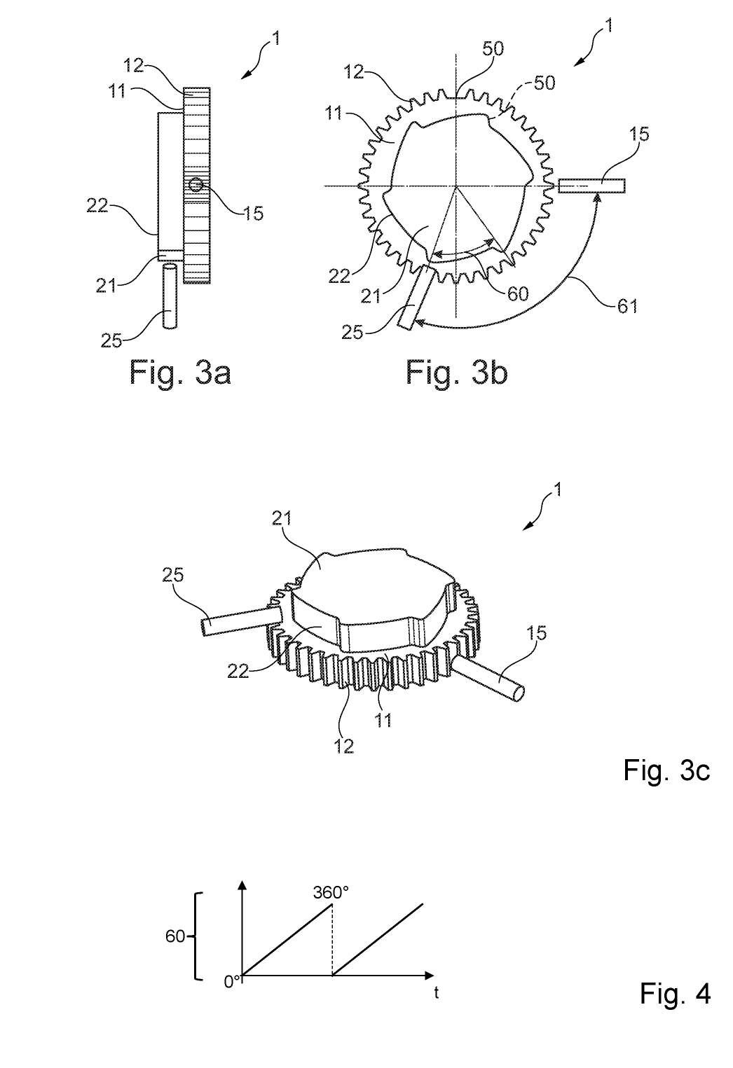

FIGS. 3a, 3b, 3c show differing views of a device 1 based on FIG. 1, the device 1 additionally having an absolute material measure 21 and an absolute-measure sensor 25 disposed opposite the absolute material measure 21. The rotor is connected to an electric machine having six pole pairs, or it is the rotor of the electric machine. The absolute material measure 21 has an encoder contour 22, and the absolute-measure sensor 25 is a distance sensor that is set up to measure a distance from the absolute material measure 21. The encoder contour 22 has a radially varying distance and, disposed around its perimeter, six repeating regions that each have a minimum and a maximum radial distance from the midpoint of the axis on which the contour is mounted. The regions each cover a rotor angular range of 60° in this case that is also covered by a pole pair of the electric machine. This angular range corresponds to a pole angular range of a pole angle 60 of the electric machine, of 360°. The increment-measure sensor 15 and the absolute-measure sensor 25 are offset in relation to each other by an angle 61 in the range of from 45° to <180°, here approximately 120°. The incremental material measure 12 has a reference mark 50 in the form of a tooth gap that is wide, unlike the rest of the tooth gaps. As an alternative or in addition to the reference mark 50, further tooth gaps may constitute a reference mark, and/or one/or more ramps or step changes in the encoder contour may constitute a reference mark (indicated by a broken line). The evaluating unit 30 is set up, after detection of the reference mark 50, to switch over to an absolute rotational angle determination on the basis of the incremental material measure 12.

FIG. 4 shows a diagram to illustrate the step of measuring an absolute rotational angle. A distance signal that corresponds approximately to the pole angle 60 is measured and used as a pole angle 60. Upon starting of the electric machine or during the measurement, the distance sensor 25 measures a distance from the encoder contour 22. This distance, which is present only six times around the circumference, is then used to unambiguously deduce the instantaneous pole angle 60, as a rotor parameter, within a pole angular range of 360°. This distance varies periodically, as shown in the diagram. A step change is effected at the transition from one region to the next. In the meantime, an incremental measurement, e.g. to calculate the rotor rotational speed, is already performed by the increment-measure sensor 15 and the incremental material measure 11, as in FIGS. 1a, 1b, 1c and 2. As soon as the reference mark 50 passes the increment-measure sensor 15, this precise absolute position is adopted as absolute-value information and used to correct the absolute-value position obtained by the distance sensor. A rotor parameter determination, by which angles and/or angular velocities and/or angular accelerations that are unambiguous and accurate, in the accuracy of the time resolution of the prediction, are also determined in intermediate rotational positions, either for a pole angular range of 360° or a rotor angular range of 360°, can now be effected solely by the incremental material measure.

By this, in particular, absolute-angle information is obtained upon switch-on of the measuring device, such that an effective closed-loop control of the electric machine can already be effected in the period before the passage of a reference mark 50. The switchover to the determination of rotor parameters, to prediction by the incremental material measure, then allows a very high degree of precision. An absolute pole angle that is necessary for commutation is already obtained at the beginning (initial). An absolute pole angle having a high accuracy (angle prediction) is obtained after attainment of the reference mark, with the result that a combined sensing of rotational speed and angle, necessary for counter-excitation, can also be effected with a high degree of accuracy.

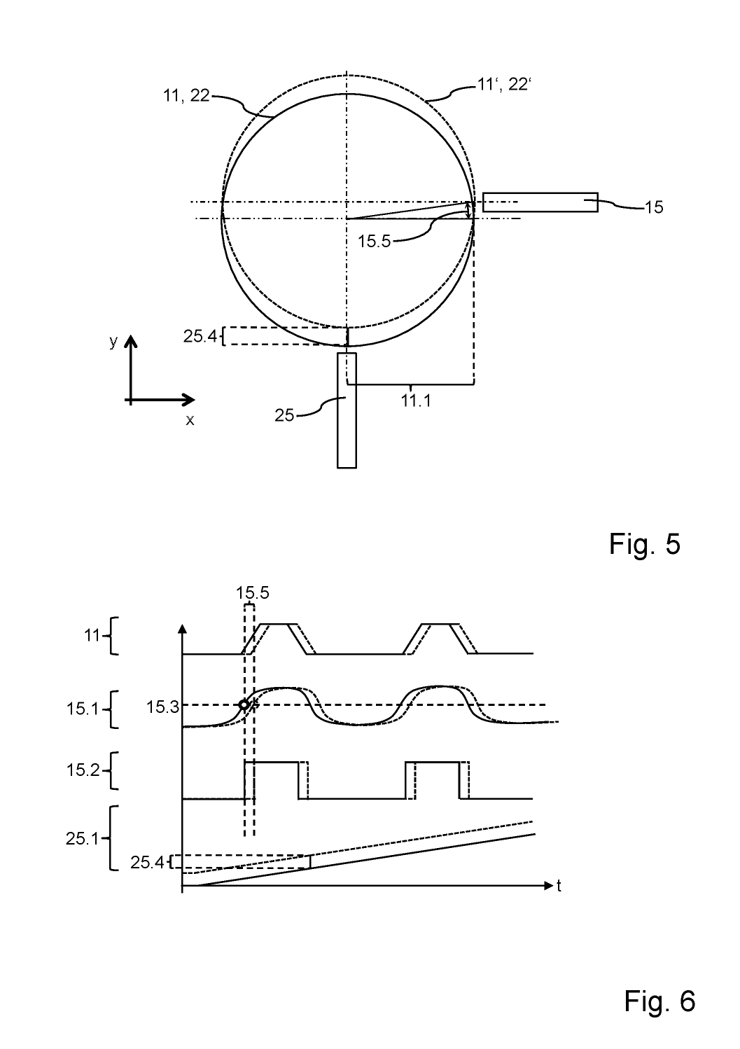

FIG. 5 shows an arrangement of an increment-measure sensor 15 and absolute-measure sensor 25 with a mutual offset of 90° and an indicated misalignment. Originally, the encoder contour 22 and the incremental material measure 11 were centered (indicated by the broken-line circle 11′, 22′). A radial offset in the y direction, by a distance difference y 25.4, has appeared, caused by, for example, unbalance (revolving error, which produces a wobble motion) or, as represented here, by an axial offset (fixed error). This results in an angle error a 15.5 in the measurement of the rotational angle by the increment-measure sensor 15, at a point on the incremental material measure 11 having a radius r 11.1.

FIG. 6 shows a diagram to illustrate the computational compensation of the misalignment shown in FIG. 5. The incremental material measure 11 has teeth, with tooth gaps. The time characteristic of the incremental material measure 11 from the point of view of the sensor 15 is represented as the topmost graph, followed underneath by the increment-measure sensor signal 15.1, with a threshold value 15.3 and the conditioned TTL signal 15.2. Also plotted, finally, is the characteristic of the absolute-measure sensor signal 25.1. The graphs that would have been obtained in the original, correctly adjusted state are each plotted with broken lines. The graphs that are obtained without compensation in the misaligned state are plotted with unbroken lines. It can be seen that a rotational angle error a 15.5 is obtained for the rotational angle measured by the increment-measure sensor 15. The misalignment gives rise to an offset of the absolute-measure sensor signal 25.1 equivalent to the distance difference y 25.4.

For the purpose of compensating the angle error a 15.5, the distance difference y 25.4 is determined by an extreme-value comparison of one or more extreme values (min/max), of a stored reference characteristic (e.g. a signal characteristic stored directly after the correct adjustment, plotted with a broken line) with the present absolute-measure sensor signal 25.1 (plotted with an unbroken line). This distance difference is used to compensate the angle error of the rotational angle on the increment-measure sensor 15 by a trigonometric function, e.g. Equation 5 or Equation 5′. Preferably, any radial offset in the x direction is compensated by an adaptation of the tripping threshold 15.3 in the analog signal 15.1 of the rotational speed sensor.

In this way, misalignments can be compensated effectively and with little resource requirement.

The invention has provided a measuring device for a rotor, with which the angular velocity of the rotor is deduced, e.g. by TTL measurements of a sensor, by increment marks, e.g. tooth flanks of a toothed-wheel contour. For this purpose, the device has an increment-measure sensor. In a development, the device has an absolute material measure, e.g. a coaxial encoder contour, provided on the rotation axis. The encoder contour is radially variable around its circumference. The absolute position, or an absolute rotational angle (either in respect of a complete revolution or over sub-regions of a complete revolution) of the encoder wheel can be deduced by distance measurements of a corresponding absolute-measure sensor. If the encoder contour preferably corresponds with the number of pole pairs of the electric motor, the relative position of the poles of the rotor of the electric motor in relation to the stator can be deduced with an even greater accuracy and without intermediate calculations, with the extent of the variation of the encoder contour unchanged. The absolute position of the rotor at a particular instant can be deduced by a preferred reference mark on the circumference of the toothed wheel or encoder wheel contour. Alternatively, the absolute material measure may also have an axial encoder contour that is correspondingly axially variable. Advantageously, the distance measuring instrument and the rotational speed measuring instrument are spaced apart from each other at an angle of between 45° and <180°. In this way, a radial or axial offset that arises because of unbalance or axial offset, or a radial or axial offset between the encoder contour and the toothed wheel contour, which would result in “wobble”, can be ascertained and compensated via software.

Determination of the current angular velocity and its variation with time makes it possible to deduce a current position of the rotor, including between two increment marks, e.g. flanks of the toothed wheel contour, on the basis of the toothed wheel contour and preferably the reference mark. Furthermore, by use of the encoder contour, a relative position between the rotor and stator can be determined already at the starting instant.

Preferably, this accurate rotational speed information is used to reduce residual rotation irregularities after the vibration damper, by appropriate control of the electric motor in the hybrid drivetrain.

### LIST OF REFERENCE NUMBERS

1 device for measuring a rotor parameter
11 incremental material measure
11.1 radius r of the incremental material measure
12 increment mark
12.1 first increment mark
12.2 second increment mark, adjacent to the first increment mark
15 increment-measure sensor
15.1 increment-measure sensor signal
15.2 conditioned signal
15.3 threshold value
15.5 angle error a
21 absolute material measure
22 encoder contour
25 absolute-measure sensor
25.1 absolute-measure sensor signal
25.4 distance difference y
30 evaluating unit
40 time-measuring instrument
40.1 time-measuring instrument signal
40.2 time resolution
40.3 counter status at t1
40.4 counter status at t*
50 reference mark
60 pole angle
61 offset angle

1. A device for measuring a rotor parameter or a plurality of rotor parameters, comprising:
an incremental material measure, which is connected to a rotor or stator in a rotationally fixed manner and which has increment marks,
an increment-measure sensor that is disposed opposite the incremental material measure, and that is disposed on the stator for the incremental material measure being connected to the rotor in a rotationally fixed manner, and that is disposed on the rotor for the incremental material measure being connected to the stator in a rotationally fixed manner,
and an evaluating unit,
a time-measuring instrument, which is set up to be reset and restarted subsequent to each passage of an increment mark,
and the evaluating unit configured to determine, in dependence on a value from the time-measuring instrument, the rotor parameter for an intermediate rotational position of the rotor that lies between a first rotational position and a second rotational position, wherein the rotor has the first rotational position at a first instant of a passage of a first increment mark and the rotor has the second rotational position at a second instant of a passage of a second increment mark that is adjacent to the first increment mark.

2. The device as claimed in claim 1, wherein the evaluating unit is configured to determine an absolute rotational angle, as the rotor parameter, by at least one inductance measurement of an electric motor that is coupled to the rotor or to which the rotor belongs.

3. The device as claimed in claim 1, further comprising an absolute material measure, and an absolute-measure sensor that is disposed opposite the absolute material measure.

4. The device as claimed in claim 3, wherein the absolute material measure has an encoder contour, and the absolute-measure sensor is a distance sensor that is set up to measure a distance from the encoder sensor.

5. The device as claimed in claim 3, wherein the increment-measure sensor and the absolute-measure sensor are offset relative to each other by an angle in a range of from 45° to <180°.

6. The device as claimed in claim 1, wherein the rotor parameter or one of the rotor parameters is a rotational angle, and the evaluating unit is set up, after a determination of an absolute rotational angle, to switch over to an absolute rotational angle determination based on the incremental material measure.

7. A method for measuring a rotor parameter or a plurality of rotor parameters, comprising:
sensing a passage of an increment mark of an incremental material measure, connected to a rotor or stator in a rotationally fixed manner, past an increment-measure sensor that is disposed opposite the incremental material measure, and that is disposed on the other of the stator;
starting a time-measuring instrument of an evaluating unit subsequent to a passage of a first increment mark past the increment-measure sensor, wherein the rotor has a first rotational position at an instant of passage of the first increment mark;
resetting and starting the time-measuring instrument subsequent to a passage of a second increment mark that is adjacent to the first increment mark, wherein the rotor has a second rotational position at an instant of passage of the second increment mark; and
determining the rotor parameter in dependence on a value of the time-measuring instrument for an intermediate rotational position of the rotor that lies between the first rotational position and the second rotational position.

8. The method as claimed in claim 7, further comprising:
measuring an absolute rotational angle by an absolute material measure and by an absolute-measure sensor that is disposed opposite the absolute material measure.

9. The method as claimed in claim 8, wherein the measuring of the absolute rotational angle is effected by a distance measurement between a distance sensor provided as the absolute-measure sensor, and an encoder contour of the absolute material measure.

10. The method as claimed in claim 7, wherein the rotor parameter or one of the rotor parameters is a rotational angle, and the method further comprises:
switching over to an absolute rotational angle determination based on the incremental material measure, after the determination of an absolute rotational angle.

11. A method for reducing rotational inequalities of a rotor of an electric motor, or of a rotor that is kinematically connected to the rotor of the electric motor, comprising:
measuring a rotor parameter;
controlling the electric motor in dependence on the rotor parameter for generating a vibration-damping moment upon the rotor, and
carrying out the measuring according to the method as claimed in claim 7.
